(19) United States
(12) Patent Application Publication
(10) Pub. No.: US 2007/0124508 A1
(43) Pub. Date: May 31, 2007

(54) Keypad, particularly a point of sale keypad, and method for placing it into operation and for exchanging and updating firmware of the keypad

(76) Inventors: Juergen Lieb, Gochsheim (DE); Bernd Grossmann, Bad Neustadt a.d. Saale (DE); Reiner Walch, Muennerstadt (DE)

Correspondence Address: MCGRATH, GEISSLER, OLDS & RICHARDSON, PLLC, P.O. BOX 1364, FAIRFAX, VA, 22038-1364, US

(21) Appl. No.: 11/518,439

(22) Filed: Sep. 11, 2006

Related U.S. Application Data
(63) Continuation of application No. PCT/EP05/02646, filed on Mar. 11, 2005.

(30) Foreign Application Priority Data
Mar. 11, 2004 (DE) DE 102004012337.3

(51) Int. Cl. G06F 3/00

(52) U.S. Cl. 710/1

(57) ABSTRACT

A keypad, particularly a point of sale keypad, is disclosed that includes a key block, a microprocessor, at least one read-only memory, in which the firmware required for operating the keypad is stored, and at least one interface for connecting the keypad to an external device. Further, a method is disclosed for starting up the keypad and for replacing or updating the keypad firmware. So that it is usually not necessary to open the keypad to replace or update the firmware, the invention proposes providing at least one programmable read-only memory in the keypad, in which a boot program and the firmware are stored in separate memory areas, and in such a way that the first memory area containing the boot program cannot be erased during normal operation of the keypad. In contrast, the second memory area, containing the firmware, of the programmable memory can be electrically erased and rewritten, so that replacing or updating the keypad firmware can occur via the keypad interface externally and thereby without opening the keypad.

This nonprovisional application is a continuation of International Application PCT/EP2005/002646, which was filed on Mar. 11, 2005, and which claims priority to German Patent Application No. DE 102004012337, which was filed in Germany on Mar. 11, 2004, and which are both herein incorporated by reference.

### BACKGROUND OF THE INVENTION

1. Field of the Invention

The present invention relates to a keypad, particularly a point of sale keypad, with a key block, a microprocessor, at least one read-only memory, in which the firmware required for operating the keypad is stored, and at least one interface for connecting the keypad to an external device. The invention relates furthermore to a method for starting up the keypad and to a method for replacing or updating the keypad firmware.

2. Description of the Background Art

In conventional point of sale (POS) keypads, called POS keypads below, a suitable read-only memory (PROM or EPROM) must be manually replaced during the replacement or updating of the keypad firmware.

This type of replacement of the read-only memory is relatively time-consuming and costly, because the specific keypad must first be opened and the hardware components (PROMs or EPROMs) manually removed from the circuit board of the corresponding keypad electronics and replaced by new or newly programmed components. In addition, special development tools for programming the read-only memory are needed.

Furthermore, because a guarantee for the particular keypad is forfeited if it is opened by unauthorized personnel, with known keypads either technical personnel has to be called in when necessary or the keypad must be sent back to the manufacturer or a sales office.

### SUMMARY OF THE INVENTION

It is therefore an object of the present invention to provide a keypad, in which it is usually not necessary to open the keypad to replace or update the firmware. Furthermore, a method for starting up the keypad and a method for replacing or updating of keypad firmware are to be provided.

The invention is based on the idea of providing at least one programmable read-only memory in the keypad, in which a boot program and the firmware are stored in separate memory areas, and in such a way that the first memory area containing the boot program cannot be erased during normal operation of the keypad. In contrast, the second memory area, containing the firmware, of the programmable memory can be electrically erased and rewritten, so that replacing or updating the keypad firmware can occur via the keypad interface from outside, and thereby without opening of the keypad. The new firmware can be transmitted to the keypad, for example, by a sales computer connected to the keypad interface, whereby the sales computer designates the arithmetic unit used as the input device for the keypad during normal operation.

If as an exception both memory areas of the programmable read-only memory are to be erased and rewritten, the memory management of the keypad of the invention is designed so that this cannot occur during normal keypad operation. Rather, the keypad must be opened for this, as is also the case in known keypads, and the entire memory area erased with a suitable development tool (e.g., a hardware flasher) and then rewritten.

When the keypad is started up, the boot program is executed first in a first submemory. After a system check, either the firmware in a second submemory is run or the firmware is replaced or updated. In the system check, the integrity of the firmware in particular is checked.

It has proven advantageous to use a flash memory as the programmable memory, particularly if this type of memory is integrated into the processor. The memory can include at least two separate submemories, whereby the first memory area contains the boot program and cannot be erased during normal operation and the second submemory contains the firmware and can be erased and rewritten (blockwise).

The user can be informed of the need to replace or update the firmware, for example, by an audible message, a text message on the external device, or a display on the keypad.

The term external device means all devices to which the keypad can be connected. This can be, for example, a completely separate device in its own housing. But it can also be a device in which the keypad is integrated as a module.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a block diagram of a keypad device according to an embodiment of the present invention;

FIG. 2 shows a block diagram of another embodiment of the keypad device of the invention; and

FIG. 3 illustrates a diagram of a program sequence during an update of the keypad firmware in the keypad of the invention.

### DETAILED DESCRIPTION

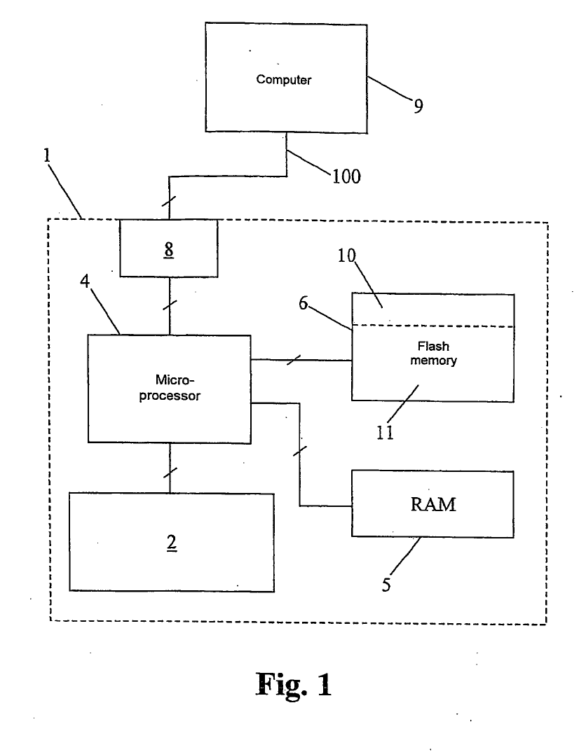

In FIG. 1, a POS keypad is designated by the number 1, which essentially comprises a key block 2, a microprocessor 4, a programmable read-only memory 6, in which the firmware required for operating keypad 1 is stored, and at least one interface 8 for connecting the keypad to an external device 9.

The microprocessor 4 is connected to an interface 8, which in the shown embodiment is connected by wire to an arithmetic unit 9 via line 100. Alternatively, a wireless connection can be provided. Keypad block 2 is connected directly to the inputs of microprocessor 4.

In addition, microprocessor 4 is connected both to a working memory (RAM) 5 and to a programmable read-only memory 6, whereby the read-only memory 6 is a flash memory. The programmable read-only memory 6 comprises a first memory area 10, which cannot be erased and written during normal operation of keypad 1 and in which the program necessary to boot keypad 1 is stored. Furthermore, the programmable read-only memory 6 has a second memory area 11, which contains the firmware of keypad 1 and can be erased and written during normal operation and which can be erased and written via interface 8 of keypad 1.

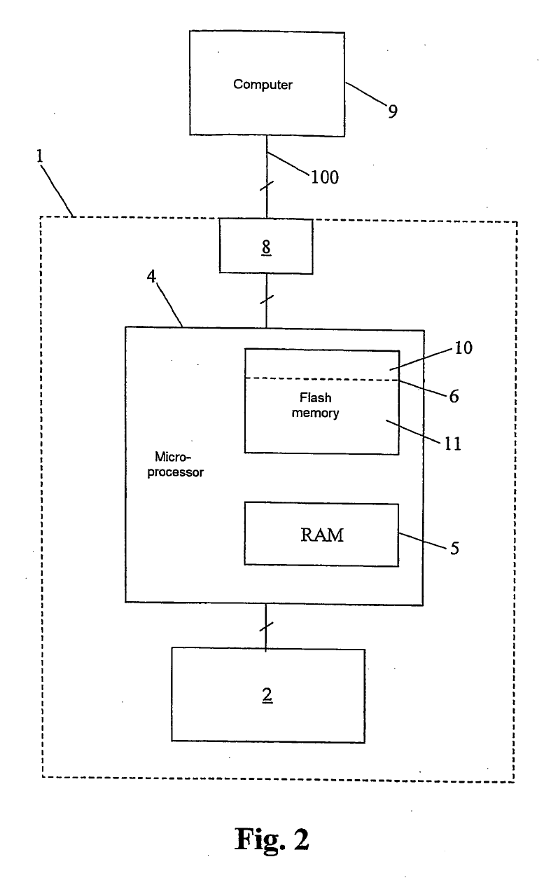

FIG. 2 shows an alternative embodiment of POS keypad 1, in which working memory 5 and read-only memory 6 are integrated into microprocessor 4. Otherwise, the design corresponds to that of keypad 1 of FIG. 1.

The management of flash memory 6 is organized with the use of microprocessor 4 in such a way that during normal operation only memory area 11 can be erased and rewritten (blockwise), but not memory area 10, in which the boot program is located.

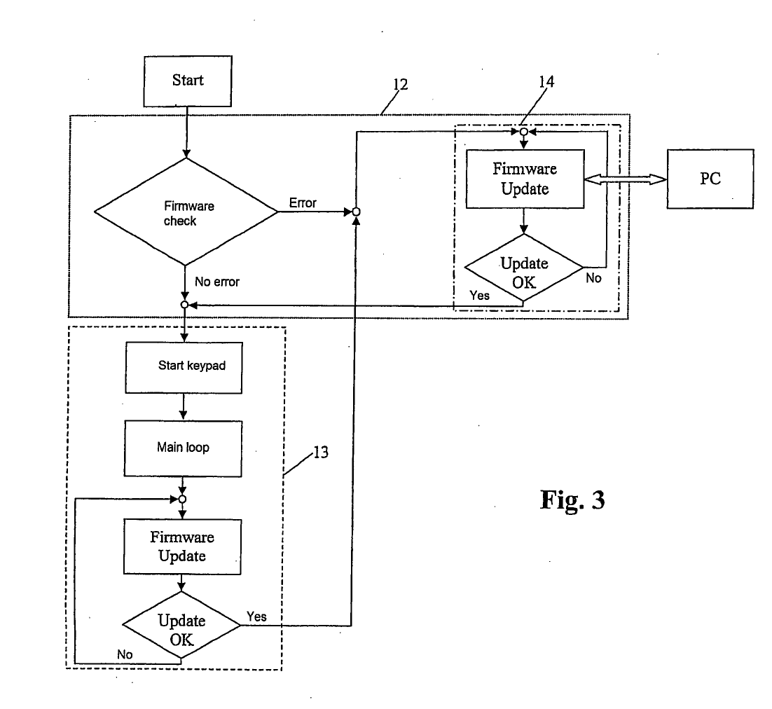

With a normal start of the keypad (application of an operating voltage to the keypad electronics, pressing the reset button), first in a program section designated as the bootloader area 12 in FIG. 3, an automatic check of the most important hardware system components and the integrity of the firmware takes place, the latter, for example, with use of a check sum. If no error is found, the program section, designated as the firmware area 13 in FIG. 3, is started and the appropriate program is loaded from memory area 11 into working memory 5 (FIGS. 1 and 2), so that keypad 1 is then operational.

By pressing one of the keys of keypad block 2, an electrical signal, which is fed to microprocessor 4, is generated in a conventional manner. Microprocessor 4 then reads out, e.g., the character corresponding to the specific key code or an assigned function or operation from a programmable memory (not shown) and transmits the appropriate information via interface 8 and line 100 to computer 9. The aforementioned programmable memory is a separate memory component, alternatively also read-only memory 6 or working memory 5.

If, in contrast, an error is found during the firmware check, boot area 12 remains active and switches to operating state “firmware update,” which is labeled with the reference character 14 in FIG. 3, i.e., the boot area waits for an update. This status is indicated on a light-emitting diode, not shown in the figures, in keypad 1.

For replacement or updating, a suitable program is started in arithmetic unit 9. By means of the boot program stored in keypad 1, the firmware is transmitted via interface 8 of keypad 1 from external device 9 into the second memory area 11, reserved for the firmware, of programmable read-only memory 6. The first memory area 10 of flash memory 6, in contrast, remains protected and unchanged. The external device 9 here is a sales computer. Alternatively, it is a maintenance computer, for example, a notebook, or a special programming device, to which the keypad is connected for the update.

As soon as the new firmware is successfully loaded into flash memory 6 of keypad 1, the firmware area designated by 13 in FIG. 3 is started and the appropriate program is loaded into working memory 5, so that keypad 1 is then operational.

The invention is, of course, not limited to the exemplary embodiment described above. Thus, the programmable memory need not absolutely be a flash memory, but other electrically programmable read-only memories (such as an EEPROM) can also be used, provided the memory organization of the keypad is designed in such a way that during normal operation only the memory area containing the other firmware can be erased and written by an external device. Furthermore, several separate memories can be used, whereby the boot program is stored in a first read-only memory and the firmware in a second programmable read-only memory. In addition, individual components, for example, the keypad controller, need not be present or other electronic components such as LEDs can be added.

Furthermore, the keypad can be designed in such a way that the firmware update is initiated by the connected arithmetic unit 9. This can occur locally on site or via a network or via the Internet by remote maintenance.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A keypad comprising:
a key block;
a microprocessor;
at least one programmable read-only memory, in which firmware required for operating the keypad is stored; and
at least one interface for connecting the keypad to an external device,
wherein the programmable read-only memory comprises a first memory area, which cannot be erased and written during normal operation of keypad, and in which the program necessary to boot the keypad is stored, and
wherein the programmable read-only memory has a second memory area, which contains the firmware of the keypad and can be erased and written during normal operation and which can be erased and written via interface of keypad.

2. The keypad according to claim 1, wherein the programmable read-only memory is a flash memory.

3. The keypad according to claim 1, wherein the programmable read-only memory is integrated into the microprocessor.

4. The keypad according to claim 1, wherein the programmable read-only memory includes at least two separate submemories, wherein the first submemory contains the boot program and the second submemory contains the firmware.

5. The keypad according to claim 1, wherein the connection between the keypad and the external device is wireless or wired.

6. A method for starting up a keypad, according to claim 1, wherein, first a boot program is executed in a first submemory, which after a system check executes either the firmware in a second submemory or performs a replacement or update of the firmware.

7. A method for replacing or updating the firmware of a keypad, according to claim 1, wherein, via the boot program stored in the keypad, the firmware is transmitted via the interface of the keypad from an external device into the second memory area, reserved for the firmware, of the programmable read-only memory.

8. The method according to claim 7, wherein the firmware is provided by an external device that is a sales computer.

9. The method according to claim 7, wherein the firmware is provided by an external device that is a maintenance computer.

10. The method according to claim 7, wherein the firmware is provided by an external device that is a programming device.

11. The keypad according to claim 1, wherein the keypad is a a point of sale keypad.
